(19) United States
(12) Patent Application Publication
(10) Pub. No.: US 2022/0410803 A1
(43) Pub. Date: Dec. 29, 2022

(54) ASPHALT COMPACTOR BIRDS EYE CAMERA INTEGRATION

(71) Applicant: Caterpillar Paving Products Inc., Brooklyn Park, MN (US)

(72) Inventors: John L. Marsolek, Watertown, MN (US); Matthew D. Chisholm, Maple Grove, MN (US); Kent A Hoisington, Mound, MN (US)

(73) Assignee: Caterpillar Paving Products Inc., Brooklyn Park, MN (US)

(21) Appl. No.: 17/355,757

(22) Filed: Jun. 23, 2021

(51) Int. Cl. B60R 1/00; E01C 19/26

(52) U.S. Cl. CPC B60R 1/00; E01C 19/26; B60R 2300/8093; B60R 2300/303; B60R 2300/302; B60R 2300/301; B60R 2300/607; B60R 2300/8086; B60R 2300/105; B60R 2300/207; B60R 2300/307; B60R 2300/8033

(57) ABSTRACT

A compactor machine can include a machine frame; at least one cylindrical roller drum rotatably coupled to the machine frame and rotatable about a drum axis oriented generally transverse to a direction of travel of the compactor machine; a plurality of cameras mounted to the machine frame so as to provide a 360° bird's eye view of an area around the machine; a display showing the 360° bird's eye view; and a controller; wherein, the controller is configured to determine certain conditions regarding a compacting operation of the compactor machine and the controller overlays a highlight symbol on the 360° bird's eye view on the display notifying a machine operator of the certain conditions.

### TECHNICAL FIELD

This disclosure relates to road construction equipment, and more specifically to a compactor machine with roller drums for traveling over a surface to be compacted.

### BACKGROUND

Compactors are machines used to compact initially loose materials, such as asphalt, soil, gravel, and the like, to a densified and more rigid mass or surface. For example, asphalt compactors are utilized to compact a freshly laid asphalt mat at construction sites. Most asphalt compactors include a rotatable roller drum that may be rolled over the surface to compress the material underneath. In addition to utilizing the weight of the roller drum to provide the compressive forces that compact the material, some compactors are configured to also induce a vibratory force to the surface.

Currently the compaction process is very monotonous and relies on the operator to pay close attention to the task at hand. An incorrect process due to the operator not paying attention can lead to poor quality and machine damage.

Chinese Patent CN 110983914 discusses a road roller with a 360-degree panoramic camera system and a display.

### SUMMARY

In an example according to this disclosure, a compactor machine can include a machine frame; at least one cylindrical roller drum rotatably coupled to the machine frame and rotatable about a drum axis oriented generally transverse to a direction of travel of the compactor machine; a plurality of cameras mounted to the machine frame so as to provide a 360° bird's eye view of an area around the machine; a display showing the 360° bird's eye view; and a controller; wherein, the controller is configured to determine certain conditions regarding a compacting operation of the compactor machine and the controller overlays a highlight symbol on the 360° bird's eye view on the display notifying a machine operator of the certain conditions.

In another example according to the present disclosure, a method of providing an operator information during operation of a compactor machine can include mounting a plurality of cameras configured to provide a 360° bird's-eye view of a compactor machine and an area surrounding the compactor machine; displaying the 360° bird's-eye view on a display that is operatively coupled to the plurality of cameras; and determining certain conditions regarding a compacting operation and overlaying a highlight symbol on the 360° bird's eye view on the display notifying a machine operator of the certain conditions.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a side view of a compactor machine, in accordance with one embodiment.

FIG. 2 shows view of a display for the compactor machine, in accordance with one embodiment.

FIG. 3 shows schematic view of a display system, in accordance with one embodiment.

FIG. 4 shows method of providing an operator information during operation of a compactor machine, in accordance with one embodiment.

### DETAILED DESCRIPTION

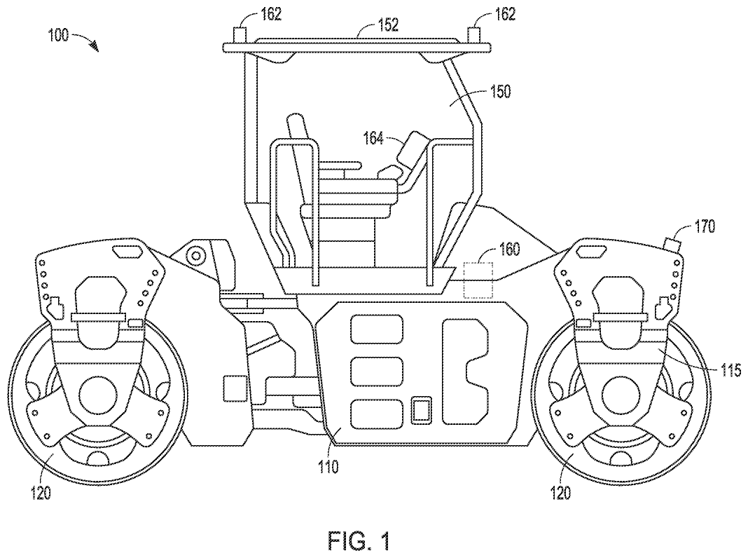

FIG. 1 shows a side view of an asphalt compactor machine 100, in accordance with one embodiment. The compactor machine 100 generally includes a body or machine frame 110 that connects and associates the various physical and structural features that enable the compactor machine 100 to function. These features can include an operator's cab 150 that is mounted on top of the machine frame 110 from which an operator may control and direct operation of the compactor machine 100. Accordingly, a steering feature and similar controls may be located within the operator's cab 150. To propel the compactor machine 100 over a surface, a power system such as an internal combustion engine can also be mounted to the machine frame 110 and can generate power that is converted to physically move the machine.

Compactor machine 100 can include at least a cylindrical roller drum 120 which is rotatable about a drum axis oriented generally transverse to a direction of travel of the compactor machine 100. The roller drums 120 is attached to the machine frame 110 using drum supports 115. The compactor machine 100 articulates such that the back section can articulate relative to the front section.

As noted above, the compaction process can be monotonous and relies on the operator to pay close attention to the task at hand. Accordingly, the compactor machine 100 can include a plurality of cameras 162 mounted to the machine frame 110 so as to provide a 360° bird's eye view of an area around the compactor machine 100. For example, four cameras 162 can be positioned above a cab roof 152. Each of the cameras 162 can provide enough coverage so that a controller 160 can stitch the various views together creating the 360° bird's eye view.

In the operator's cab 150 can be located a display 164 for showing the 360° bird's eye view to the operator. In addition, the controller 160 can be configured to determine certain conditions regarding a compacting operation and the controller 160 can overlay a highlight symbol on the 360° bird's eye view on the display 164 notifying a machine operator of the certain conditions.

In this example, the compactor machine 100 can include a temperature sensor 170 to determine temperature of an asphalt mat in the machine path in front of the compactor machine 100. In one example, the temperature sensor 170 can include an infrared sensor positioned so as to be directed at the asphalt mat in front of the compactor machine 100.

Thus, the present system can integrate a 360° camera view on the machine 100. In one embodiment, the 360° camera system can contain four or more cameras 162 that are mounted on the cab roof 152 and provide 360° stitched coverage around the machine 100. As will be further detailed below, implementing this feature allows the display system to be integrated with other machine sensors so that the operator display 164 can allow for visualizing and displaying warning symbols of objects such as other machines, manhole covers, curbs, people, low temperature spots, etc.

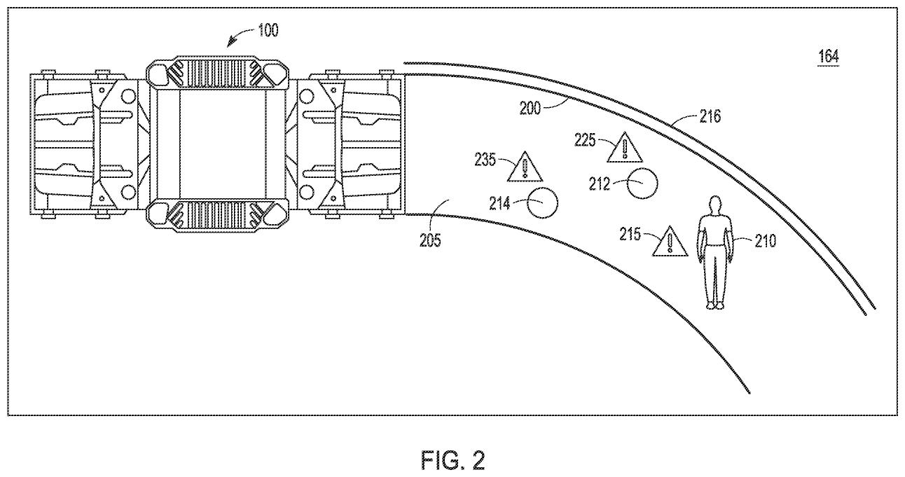

For example, FIG. 2 shows view of the display 164 for the compactor machine 100, in accordance with one embodiment.

Here, the display 164 is showing the 360° bird's eye view around the machine 100. The display 164 further can show a machine path 200 of the compactor machine 100 based on a location of the machine 100, a speed of the machine 100, and the steering angles of the machine 100. The controller 160 of the compactor machine 100 can receive all this information from various sensors on the compactor machine 100 and can be configured to determine the predicted machine path 200 based on the information. The controller 160 then overlays the machine path 200 onto the 360° bird's eye view.

As noted, the controller 160 can be configured to determine certain conditions regarding a compacting operation and the controller 160 can overlay a highlight symbol on the 360° bird's eye view on the display 164 notifying a machine operator of the certain conditions.

For example, the certain conditions can include one or more obstacles in or near the machine path 200 and the controller 160 can highlight the one or more obstacles on the display 164. In some examples, the cameras 162 can be smart cameras able to classify objects in the machine path 200. Thus, the software and hardware of the cameras 162 can be considered part of the controller 160. In other examples, the controller 160 classifies any anomalies it detects in the machine path 200 so as to determine what the obstacle is.

For example, the obstacle can include another machine or a person 210 in or near the machine path 200. In some examples, the controller 160 can display a highlight symbol 215 on the display 164, thus alerting the machine operator. In some examples, the controller 160 can automatically stop the machine 100 if a certain obstacle such as the person 210 is in the machine path. 200.

In some examples, the obstacle can include a man-hole cover 212 and the controller can overlay a highlight symbol 225 on the display 164 to alert the operator.

In some examples, the certain conditions determined by the controller 160 can include a high or low temperature spot 214 of the asphalt mat 205 highlighted on the display 164 with a highlight symbol 235. Accordingly, for example, if the display 164 shows the operator a high temperature for a section of the asphalt mat 205, the operator can wait until the asphalt mat temperature is in the proper range for compacting.

In some examples, the certain conditions encountered by the compactor machine 100 can include a curb 216 which will be shown on the display 164 and the controller can also show a highlight symbol to notify the operator of the curb 216. In other examples, the controller 160 can determine a desired machine path and can display guidelines on the display 164 showing the operator the desired driving path along with the actual machine path 200.

In some examples, the road plan and known features and locations along a predicted machine path can be pre-loaded into the controller 160 before operation. For example, when a road is being planned, a detailed road plan is formed, showing the locations of details and features along the new road. Some of this information can be pre-loaded into the controller 160 so that the controller, by using a location of the machine 100 from a GPS receiver in controller 160, can determine and know the location any details and features coming up along the machine path 200.

As noted, the controller 160 can further include location information using a GPS signal and the controller 160 can highlight any known features and obstacles on the display based on the pre-loaded machine path and known features along the machine path and the GPS location.

In some, examples, the display 164 can be located off-site of the compactor machine 100 allowing a supervisor to further observe the compacting process.

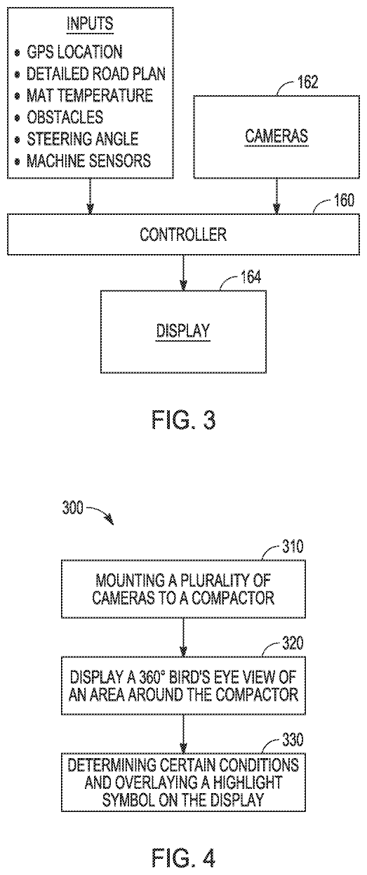

FIG. 3 shows schematic view of the present display system, in accordance with one embodiment. The display system includes the controller 160 receiving information and data from various sources, such as the camera 162, various sensors on the machine 100 and other inputs.

For example, the inputs into the controller 160 can include the GPS location of the machine 100, a pre-loaded detailed road plan which can include all the details of a proposed road including all the features and landmarks and other information tagged to GPS locations. The controller can further include asphalt temperature input from temperature sensors incorporated into the machine 100. Obstacles in the machine path can be input into the controller based on the pre-loaded detailed road plan, or from sensors on the machine 100, or from the controller classifying objects in the views received from the cameras 162. Further inputs can include steering angles of the machine, and information from other machine sensors such as machine speed. This information can be used by the controller 160 to determine a predicted driving path of the machine 100.

The display system then has the controller 160 filtering all the information into the display 164 and overlaying onto the 360° bird's eye view of the cameras 162 any further information such as highlighting obstacles, highlighting temperature warnings, and showing the driving path and driving guidelines if so equipped.

Thus, the present system integrates a 360° camera view onto the machine display. The display system can be integrated with other machine sensors so that the operator display 164 will allow for visualizing and warning of objects such as other machines, manhole covers, curbs, people, low temperature spots, etc. By integrating with the other machine sensors such as steering angle and machine speed guidance lines for projecting machines path can be integrated within the machine display 164. Objects such as curbs and avoidance items such as people and manholes could be classified by the controller 160 and displayed with highlight symbol warnings. Known objects could be classified within the machine software or a detailed plan could be loaded for the job being completed by utilizing GPS.

### INDUSTRIAL APPLICABILITY

The present system is applicable during many situations in road construction, especially for asphalt compactors.

For example, and referring to the compactor machine 100 and FIGS. 1-3, FIG. 4 depicts a method 300 of providing an operator information during operation of a compactor machine, in accordance with one embodiment.

The method 300 can include mounting a plurality of cameras (310) configured to provide a 360° bird's-eye view of a compactor machine and an area surrounding the compactor machine; displaying the 360° bird's-eye view (320) on a display that is operatively coupled to the plurality of cameras; and determining certain conditions (330) regarding a compacting operation and overlaying a highlight symbol on the 360° bird's eye view on the display notifying a machine operator of the certain conditions.

In various examples, the method 300 can further have the display showing a predicted machine path of the compactor machine based on a location of the machine, speed of the machine, and steering angles of the machine.

In one or more embodiments, the certain conditions encountered by the machine 100 can be classified by the controller and can include one or more obstacles in or near the machine path and the controller highlights the one or more obstacles on the display. In some examples, the machine path and known features along the machine path can be pre-loaded into the controller before operation. The controller can further include location information using a GPS signal and the controller can highlight the known features and obstacles on the display based on the pre-loaded machine path and known features along the machine path and the GPS location.

In one example, the compactor machine can include a temperature sensor to determine temperature of an asphalt mat in the machine path and the certain conditions include a high or low temperature warning highlighted on the display.

Accordingly, the present system allows a display to show the operator the area around the compactor machine and to highlight one or more features or obstacles around the compactor machine so as to alert the operator.

Various examples are illustrated in the figures and foregoing description. One or more features from one or more of these examples may be combined to form other examples.

The above detailed description is intended to be illustrative, and not restrictive. The scope of the disclosure should, therefore, be determined with references to the appended claims, along with the full scope of equivalents to which such claims are entitled.

What is claimed is:

1. A compactor machine comprising:
a machine frame;
at least one cylindrical roller drum rotatably coupled to the machine frame and rotatable about a drum axis oriented generally transverse to a direction of travel of the compactor machine;
a plurality of cameras mounted to the machine frame so as to provide a 360° bird's eye view of an area around the machine;
a display showing the 360° bird's eye view; and
a controller;
wherein, the controller is configured to determine certain conditions regarding a compacting operation of the compactor machine and the controller overlays a highlight symbol on the 360° bird's eye view on the display notifying a machine operator of the certain conditions.

2. The compactor machine of claim 1, wherein the display further shows a machine path of the compactor machine based on a location of the machine, a speed of the compactor machine, and steering angles of the compactor machine.

3. The compactor machine of claim 2, wherein the certain conditions include one or more obstacles in or near the machine path and the controller highlights the one or more obstacles on the display.

4. The compactor machine of claim 3, wherein the obstacles can include another machine or a person.

5. The compactor machine of claim 3, wherein the obstacle can include a man-hole cover.

6. The compactor machine of claim 2, wherein known features along the machine path can be pre-loaded into the controller before operation.

7. The compactor machine of claim 6, wherein the controller can further include location information using a GPS signal and the controller can highlight the known features on the display based on the pre-loaded known features along the machine path and the GPS location.

8. The compactor machine of claim 1, wherein the compactor machine includes a temperature sensor to determine temperature of an asphalt mat and the certain conditions include a high or low temperature warning of the asphalt mat highlighted on the display.

9. The compactor machine of claim 8, wherein the temperature sensor includes an infrared sensor directed at the asphalt mat in front of the compactor machine.

10. The compactor machine of claim 2, wherein the certain conditions include a curb and the display shows a highlight symbol at the curb in the machine path.

11. A method of providing an operator information during operation of a compactor machine, the method comprising:
mounting a plurality of cameras configured to provide a 360° bird's-eye view of a compactor machine and an area surrounding the compactor machine;
displaying the 360° bird's-eye view on a display that is operatively coupled to the plurality of cameras; and
determining certain conditions regarding a compacting operation and overlaying a highlight symbol on the 360° bird's eye view on the display notifying a machine operator of the certain conditions.

12. The method of claim 11, wherein the display further shows a machine path of the compactor machine based on a location of the machine, a speed of the compactor machine, and steering angles of the compactor machine.

13. The method of claim 12, wherein the certain conditions include one or more obstacles in or near the machine path and a controller highlights the one or more obstacles on the display.

14. The method of claim 13, wherein the obstacles can include another machine or a person.

15. The method of claim 13, wherein the obstacle can include a man-hole cover.

16. The method of claim 12, wherein known features along the machine path can be pre-loaded into a controller before operation.

17. The method of claim 16, wherein the controller can further include location information using a GPS signal and the controller can highlight the known features on the display based on the pre-loaded known features along the machine path and the GPS location.

18. The method of claim 11, wherein the compactor machine includes a temperature sensor to determine temperature of an asphalt mat and the certain conditions include a high or low temperature warning of the asphalt mat highlighted on the display.

19. The method of claim 18, wherein the temperature sensor includes an infrared sensor directed at the asphalt mat in front of the compactor machine.

20. The method of claim 12, wherein the certain conditions include a curb and the display shows a highlight symbol at the curb in the machine path.
